(19) United States
(12) Patent Application Publication
(10) Pub. No.: US 2015/0346499 A1
(43) Pub. Date: Dec. 3, 2015

(54) THREE-DIMENSIONAL DISPLAY APPARATUS

(71) Applicant: SAMSUNG ELECTRONICS CO., LTD., Suwon-si (KR)

(72) Inventors: Masaru MINAMI, Hwaseong-si (KR); Won Yong LEE, Suwon-si (KR); Keun Bae JEON, Suwon-si (KR)

(73) Assignee: SAMSUNG ELECTRONICS CO., LTD., Suwon-si (KR)

(21) Appl. No.: 14/724,275

(22) Filed: May 28, 2015

(30) Foreign Application Priority Data
May 30, 2014 (KR) 10-2014-0066240
Oct. 17, 2014 (KR) 10-2014-0140507

(51) Int. Cl. G02B 27/22; G02F 1/1335; F21V 8/00

(52) U.S. Cl. CPC G02B 27/22; G02B 6/0038; G02B 6/0076; G02B 6/0016; G02B 6/0031; G02B 6/0043; G02B 6/0055; G02B 6/0053; G02B 6/0088; G02F 1/133603

(57) ABSTRACT

A three-dimensional display apparatus is provided having a light guide module which guides to a display panel from a backlight. The three-dimensional display apparatus includes a first light guide, a second light guide, and an emission pattern which emits light toward the display panel. Viewing distances between a viewer's eyes and the display panel are determined by a thickness of the second light guide regardless of a thickness of the first light guide.

### CROSS-REFERENCE TO RELATED APPLICATION

This application claims priority from Korean Patent Applications Nos. 10-2014-0066240 and 10-2014-0140507, filed on May 30, 2014 and Oct. 17, 2014, respectively, in the Korean Intellectual Property Office, the disclosures of which are incorporated herein by reference.

### BACKGROUND

1. Field

Apparatuses consistent with exemplary embodiments relate to a three-dimensional display apparatus capable of displaying a stereoscopic image.

2. Description of the Related Art

Display apparatuses, such as monitors and televisions, are apparatuses capable of displaying images.

Recently, three-dimensional display apparatuses, which display three-dimensional images in addition to two-dimensional images, have been developed.

A three-dimensional display apparatus may include a display panel having a liquid crystal panel, and a backlight disposed to the rear of the display panel and configured to generate light to be supplied to the display panel.

A backlight may include a three-dimensional light source disposed on each side of the display panel, a light guide disposed between the two three-dimensional light sources and configured to guide light emitted from the three-dimensional light sources to the display panel located in front of the light guide, and a two-dimensional light source disposed to the rear of the light guide. Additionally, emission patterns may be formed on the light guide to scatter light, such that that light within the light guide is only transmitted out of the light guide to the display panel at locations on which the light emission pattern is formed.

In a three-dimensional display apparatus as described above, viewing distances between the eyes of a viewer and the display panel are dependent on the thickness of the light guide, and the thickness of the light guide may be very small in the case of a small display panel.

### SUMMARY

According to one of more exemplary embodiments a three-dimensional display apparatus may be provided which is capable of reducing the size of a three-dimensional display apparatus and maintaining the thickness of a light guide module having a predetermined size or more.

Additional exemplary aspects and advantages will be set forth in part in the description which follows and, in part, will be obvious from the description, or may be learned by practice of the invention.

According to an aspect of an exemplary embodiment, a three-dimensional display apparatus includes a display panel, and a three-dimensional backlight configured to supply light to the display panel, wherein the three-dimensional backlight includes a light source configured to generate light, and a light guide module configured to guide the light generated by the light source to the display panel. The light guide module includes a first planar light guide, at least one light source being on each of opposite ends of the first planar light guide, a planar second light guide disposed in front of the first planar light guide, and emission patterns configured to emit light from the light guide module toward the display panel.

Each of the emission patterns may include a reflecting portion disposed at the rear of the emission pattern and configured to reflect light, and a scattering portion disposed at a front of the emission pattern and configured to scatter light.

The emission patterns may be disposed between the first light guide and the second light guide.

Spaces between and among the emission patterns may be filled with a transparent material which transmits light.

A front surface of the first planar light guide may include grooves concavely formed therein, and the emission patterns may be formed, respectively, in the grooves.

A rear surface of the second light guide may include grooves concavely formed therein, and the emission patterns may be formed, respectively, in the grooves.

The reflecting portion may include an air layer.

A planar emission plate, disposed between the first light guide and the second light guide, and including the emission pattern, may be further included.

According to an aspect of another exemplary embodiment, a three-dimensional display apparatus includes a display panel, and a three-dimensional backlight configured to supply light to the display panel, wherein the three-dimensional backlight includes a pair of three-dimensional light sources, one of the light sources disposed at the rear of the display panel at each of both ends of a light guide module disposed between the pair of light sources. The light guide module includes a first planar light guide formed, a second planar light guide disposed in front of the first planar light guide, and a scattering pattern configured to scatter light by reflecting light incident from the first light guide at an angle of reflection the same as an angle of incidence of the light, and reflecting light incident from the second light guide at an angle of reflection greater than an angle of incidence of the light.

The scattering pattern may be formed of a light reflective material and include a planar rear surface, and a convex front surface.

The scattering pattern may be formed of a light reflective material and include a convex scattering portion comprising a front surface of the scattering patter, and an air layer comprising a rear surface of the scattering portion.

According to an aspect of another exemplary embodiment, a three-dimensional display apparatus includes a display panel, and a three-dimensional backlight configured to supply light to the display panel, wherein the three-dimensional backlight includes a light source configured to generate light, and a light guide module configured to guide light generated from the light source to the display panel. The light guide module includes a planar light guide, wherein at least one light source is disposed at each of opposite ends of the planar light guide, and a planar emission plate disposed in front of the light. The emission plate includes an emission pattern which directs light from the light guide module toward the display panel.

The emission pattern may include concave emission portions formed in a front surface of the emission plate, and reflecting portions provided on rear surfaces of the emission portions.

An upper side of each of the emission portions may have a trapezoidal cross section facing a rear surface of the light guide.

The emission portions may extend in a same direction in parallel.

The emission portions may have prismoidal shapes.

The emission portions may have square prismoidal shapes.

The emission portions may have rectangular prismoidal shapes.

The emission portions may have truncated cone shapes.

### BRIEF DESCRIPTION OF THE DRAWINGS

These and/or other exemplary aspects and advantages will become apparent and more readily appreciated from the following description of the embodiments, taken in conjunction with the accompanying drawings of which:

FIG. 1 is a schematic view of a three-dimensional display apparatus according to a first exemplary embodiment;

FIG. 2 is a schematic view of a three-dimensional display apparatus according to a second exemplary embodiment;

FIG. 3 is a schematic view of a three-dimensional display apparatus according to a third exemplary embodiment;

FIG. 4 is a schematic view of a three-dimensional display apparatus according to a fourth exemplary embodiment;

FIG. 5 is a schematic view of a three-dimensional display apparatus according to a fifth exemplary embodiment;

FIG. 6 is a schematic view of a three-dimensional display apparatus according to a sixth exemplary embodiment;

FIG. 7 is a schematic view of a three-dimensional display apparatus according to a seventh exemplary embodiment;

FIG. 8 is a schematic view of a three-dimensional display apparatus according to an eighth exemplary embodiment;

FIG. 9 is a perspective view illustrating an emission plate and an emission pattern of the three-dimensional display apparatus according to the eighth exemplary embodiment;

FIG. 10 is a cross-sectional view illustrating an emission plate and an emission pattern of the three-dimensional display apparatus according to the eighth exemplary embodiment;

FIGS. 11 and 12 are cross-sectional views illustrating a light path in the three-dimensional display apparatus according to the eighth exemplary embodiment;

FIG. 13 is a perspective view illustrating an emission plate and an emission pattern of the three-dimensional display apparatus according to the ninth exemplary embodiment;

FIG. 14 is a perspective view illustrating an emission plate and an emission pattern of the three-dimensional display apparatus according to the tenth exemplary embodiment; and

FIG. 15 is a perspective view illustrating an emission plate and an emission pattern of the three-dimensional display apparatus according to the eleventh exemplary embodiment.

### DETAILED DESCRIPTION

Reference will now be made in detail to exemplary embodiments which are illustrated in the accompanying drawings, wherein like reference numerals refer to like elements throughout.

Hereinafter, a three-dimensional display apparatus according to a first exemplary embodiment will be described with reference to accompanying drawings in detail.

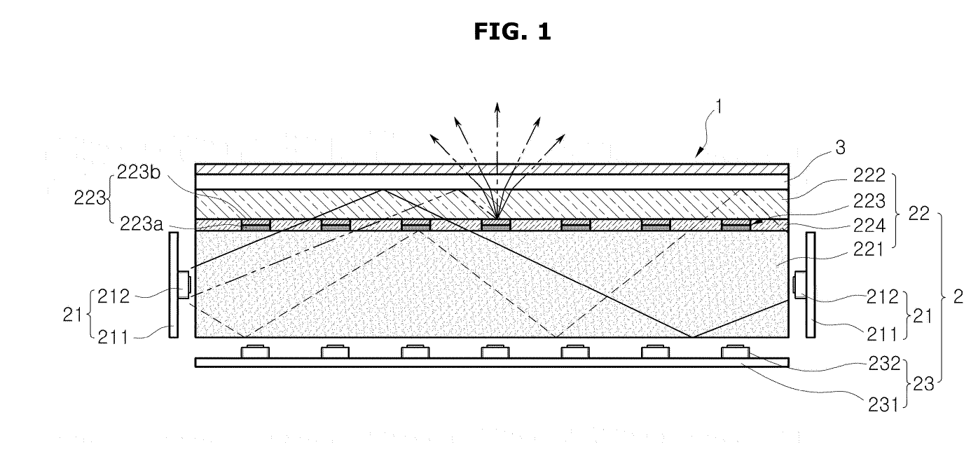

As shown in FIG. 1, a three-dimensional display apparatus according to the first embodiment includes a display panel 1 on which an image is displayed, backlight 2 which generates light to be supplied to the display panel 1, a light guide module 22, and a spacer 3 which is disposed between the display panel 1 and the light guide module 22 and constantly maintains a spacing between the display panel 1 and the light guide module 22.

The display panel 1 is formed by a liquid crystal panel having an approximately square planar shape.

The backlight 2 includes a pair of three-dimensional light sources 21 which are disposed on opposite sides of the backlight 2, to the rear of the display panel 1, the light guide module 22, which is disposed between the two three-dimensional light source 21 and which guides light emitted from the two three-dimensional light sources 21 to the display panel 1 located in front thereof, and a two-dimensional light source 23 which is disposed to the rear thereof and emits light.

Each of the two three-dimensional light sources 21 is formed in a thin bar shape and includes a substrate 211 disposed on a side of the light guide module 22, and a plurality of light emitting diodes 212 disposed on the substrate 211, facing a corresponding side of the light guide module 22. Light emitted from the light emitting diodes 212 of the three-dimensional light sources 21 is incident into the light guide module 22 through the side ends of the light guide module 22 and is emitted to the display panel 1 through a front surface of the light guide module 22.

The two-dimensional light source 23 is formed in a planar shape corresponding to the shape of the display panel 1 and includes a substrate 231 disposed to the rear of the light guide module 22, and a plurality of light emitting diodes 232 mounted on the substrate 231. Light generated from the two-dimensional light source 23 is emitted to the display panel 1 through the light guide module 22.

The light guide module 22 is formed in a square planar shape, corresponding to the shape of the display panel 1, and includes a first light guide 221, three-dimensional backlights 2 disposed on both sides of the first light guide 221, a second light guide 222 formed in a planar shape and disposed in front of the first light guide 221, and an emission pattern 223 which reflects light incident thereon from the first light guide 221, and scatters light incident thereon from the second light guide 222 so as to emit light to the display panel 1 from the light guide module 22. Thus, the light incident into the light guide module 22 from the three-dimensional light source 21 is emitted only through a portion of the display panel 1 corresponding to a portion on which the emission pattern 223 is formed.

In this embodiment, the emission pattern 223 is formed between the first light guide 221 and the second light guide 222. A space between the first light guide 221 and the second light guide 222 in which the emission pattern 223 is not formed in is filled with a light transmission material having a refractive index similar to that of the first light guide 221 and the second light guide 222 so that light passes through the light transmission material and is transferred to the second light guide 222 from the first light guide 221.

As described above, the emission pattern 223 reflects light incident thereon from the first light guide 221 and scatters light incident thereon from the second light guide 222. To this end, the emission pattern 223 includes a reflecting portion 223a, which is disposed at the rear thereof and is formed of a light reflective material to reflect light, and a scattering portion 223b which is disposed at front of the reflecting portion 223a and is formed of a light scattering material to scatter light.

In this embodiment, the first light guide 221 and the second light guide 222 are formed of polymethyl methacrylate (PMMA). The reflecting portion 223a is formed of aluminum and the scattering portion 223b is formed of a white ink in which barium sulfate is a major component. The light transmission material 224 may be an index-matching oil of which a transparent acrylic adhesive or silicon is a major component. A light transmission material 224 in a gel form may be preferable. In the descriptions of the above-described first light guide 221, second light guide 222, reflecting portion 223a, scattering portion 223b, and light transmission material 224, any of various types of materials may be used according to design, as would be understood by one of skill in the art.

In this embodiment, the formation of the light guide module 22 includes forming the reflecting portion 223a, in which a light reflective material is stacked on the first light guide 221, using a photolithography method or the like, and then forming the scattering portion 223b, in which a light scattering material is stacked on the reflecting portion 223a, using a screen-printing method or the like. Subsequently, the second light guide 222 formed in a film shape is attached to the first light guide 221 via the light transmission material 224 having adhesive strength, and thus, the light guide module 22 is manufactured.

In the light guide module 22, light is incident on the emission pattern 223 from within the first light guide 221, is reflected by the reflecting portion 223a, and is incident again into the first light guide 221. Light incident on the emission pattern 223 from the second light guide 222 is scattered by the scattering portion 223b to be emitted to the display panel 1 through a front surface of the second light guide 222. Thus, the light guide module 22 only guides light to those portions of the display panel 1 corresponding to locations at which the emission pattern is formed.

When the light guide module 22 is formed as described above, since viewing distances between the eyes of a user and the display panel 1 are dependent on thicknesses of the second light guide 222 and the spacer 3 rather than the thickness of the first light guide 221, the desired thickness of the first light guide 221 can be freely designed by a designer. That is, even when the thickness of the second light guide 222 is thin, such when the second light guide 222 is a film, in consideration of the viewing distance, the thickness of the first light guide 221 may be freely designed by a designer so that the overall thickness of the light guide module 22 can be formed to be a predetermined size or more.

Accordingly, the design of a light guide module 22 applicable to a small three-dimensional display apparatus can be facilitated.

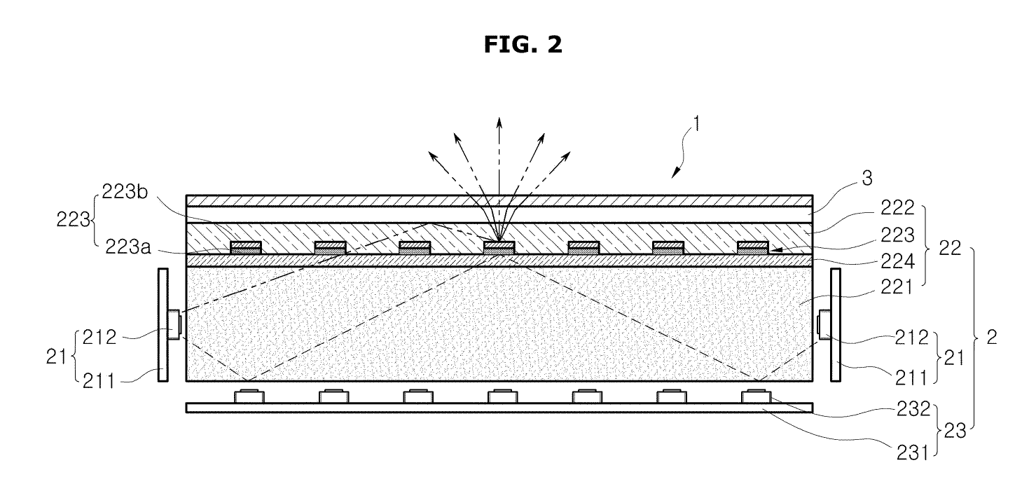

In the first exemplary embodiment as described above, although the emission pattern 223 is described as being disposed between the first light guide 221 and the second light guide 222, it is not limited thereto. According to a second exemplary embodiment shown in FIG. 2, concave grooves may be formed in the rear surface of the second light guide 222, and the emission pattern 223 may be formed in the grooves.

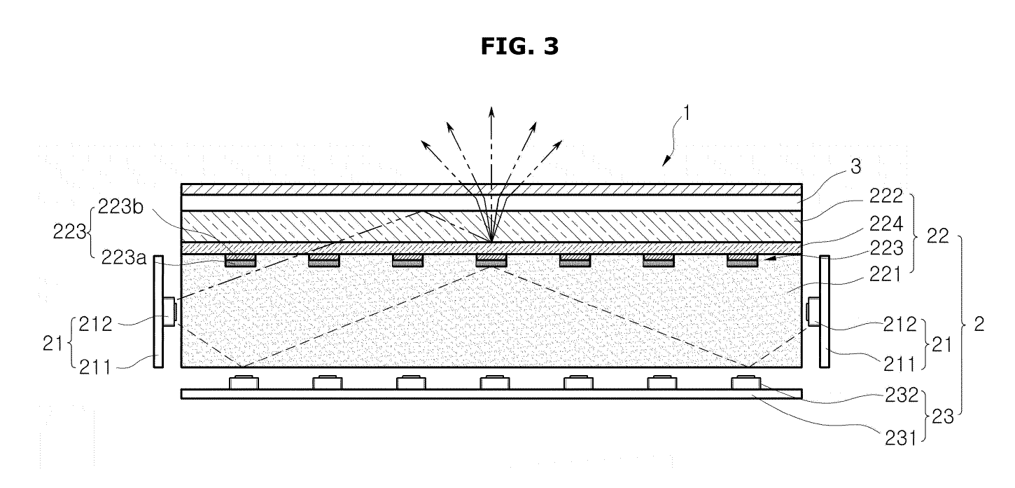

Further, according to a third embodiment shown in FIG. 3, concave grooves may be formed in a front surface of the first light guide 221, and the emission pattern 223 may be formed in the grooves.

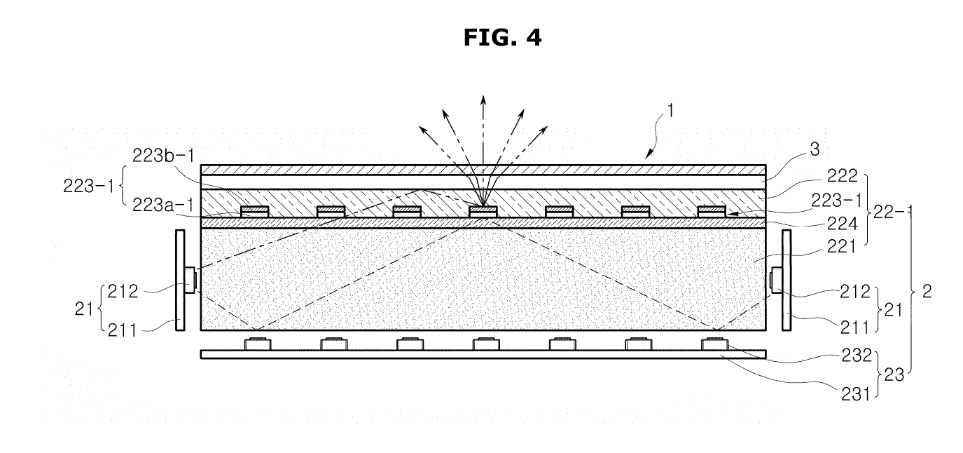

Further, when grooves are formed in the second light guide 222 and the emission pattern 223 is formed in the grooves as described above, according to a fourth embodiment shown in FIG. 4, a reflecting portion 223a-1 of the emission pattern 223-1 may bean air layer, and light can be reflected due to a refractive index difference between the first light guide 221 and the reflecting portion 223a-1 formed by the air layer.

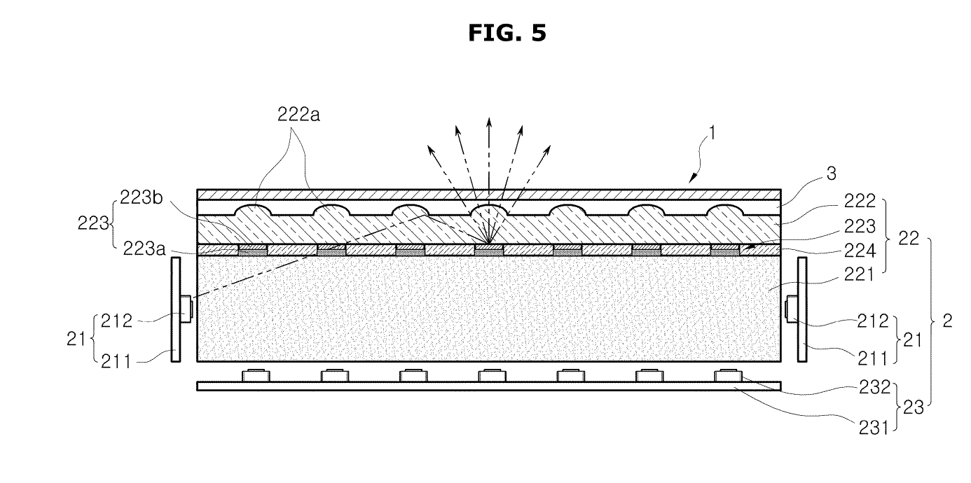

Further, according toe a fifth exemplary embodiment shown in FIG. 5, convex lenses 222a are formed in regions of the front surface of the second light guide 222 corresponding to locations of the emission pattern 223, and light scattered by the scattering portion 223b is transmitted by the lenses 222a, and thus, an amount of light to be transferred to the display panel 1 can be increased.

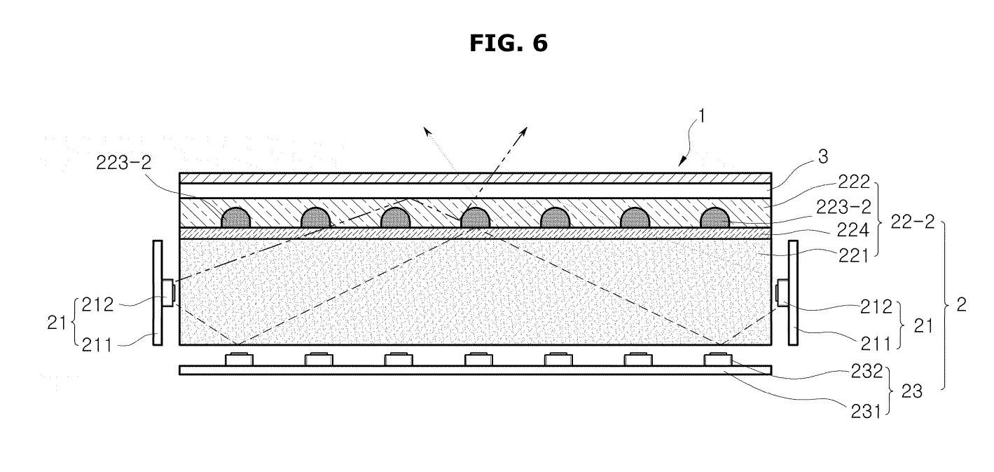

Further, in the above-described embodiments, although the emission pattern 223 is described as including the reflecting portion 223a and the scattering portion 223b, it is not limited thereto. According to a sixth embodiment shown in FIG. 6, an emission pattern 223-2 is formed of from light reflective material, the rear surface thereof is planar, and the middle of the front surface thereof is a convex curved surface. Thus, the emission pattern 223-2 may simultaneously perform the functions of reflecting light incident from the first light guide 221 and scattering light incident from the second light guide 222.

That is, since the rear surface of the emission pattern 223-2 is planar, light incident on the rear surface of the emission pattern 223-2 from the first light guide 221 is reflected at an angle of reflection the same as an angle of incidence of the light, and light incident on the front surface of the emission pattern 223-2 from the second light guide 222 is reflected at an angle of reflection greater than an angle of incidence of the light. Thus, light reflected by the front surface of the emission pattern 223-2 may be emitted through the front surface of the light guide module 22. That is, light reflection and scattering may be simultaneously performed by the emission pattern 223-2 formed of a single material.

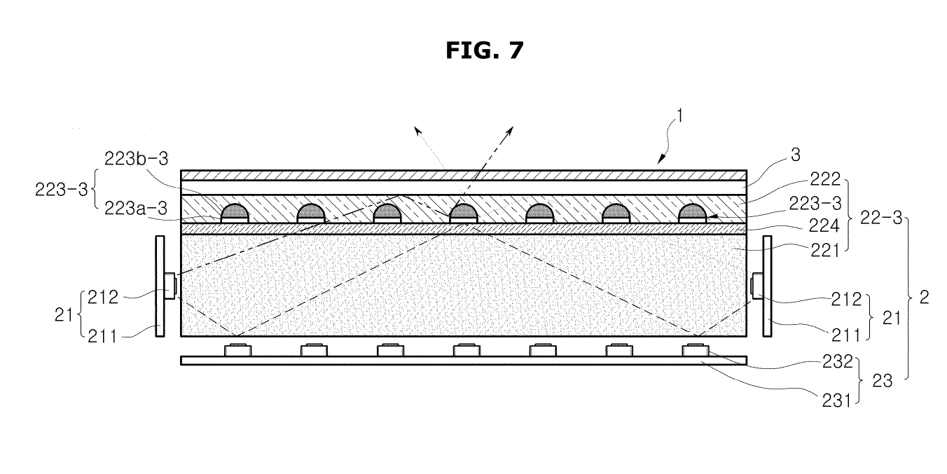

Further, according toe a seventh exemplary embodiment shown in FIG. 7, an emission pattern 223-3 of the light guide module 22 is formed of a light reflective material, and may include a scattering portion 223b-3 having a front surface which is curved, and an air layer 223a-3 formed at the rear of the scattering portion 223b-3. The emission pattern 223-3 formed as described above reflects light incident from the first light guide 221 at an angle of reflection the same as an angle of incidence of the light, and reflects light incident from the second light guide 222 at an angle of reflection greater than an angle of incidence of the light through the air layer 223a-3.

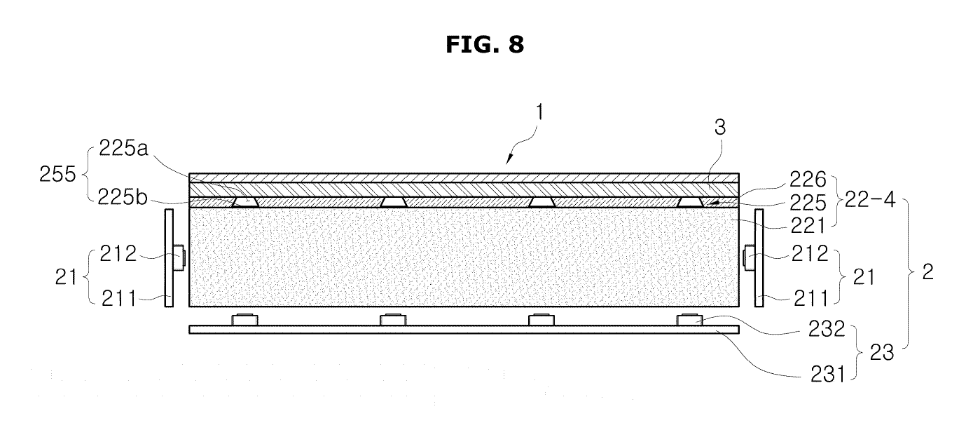

A three-dimensional display apparatus according to an eighth exemplary embodiment is shown in FIG. 8.

In this embodiment, the three-dimensional display apparatus includes a display panel 1 and a light guide module 22-4 which is disposed at the rear of a light source 21 and the display panel 1 and which guides light generated from the light source 21 to the display panel 1. A spacer 3 is disposed between the display panel 1 and the light guide module 22-4, and maintains a constant spacing between the display panel 1 and the light guide module 22-4.

The light guide module 22-4 includes a light guide 221 formed in a planar shape, and an emission plate 226 which is disposed in front of the light guide 221 and emits light incident into the light guide module 22-4 toward the display panel 1.

The light source 21 includes substrates 211 and light emitting diodes 212. The light emitting diodes 212 are disposed facing opposite side ends of the light guide 221 and light emitted from the light emitting diode 212 is incident on the light guide 221 through a side end of the light guide 221.

The emission plate 226 is formed in a planar shape corresponding to a shape of the light guide 221 and is disposed in front of the light guide 221. An emission pattern 225 is provided on the front surface of the emission plate 226 to emit light from the emission plate 226 toward the display panel 1. An air layer is formed between the emission plate 226 and the spacer 3.

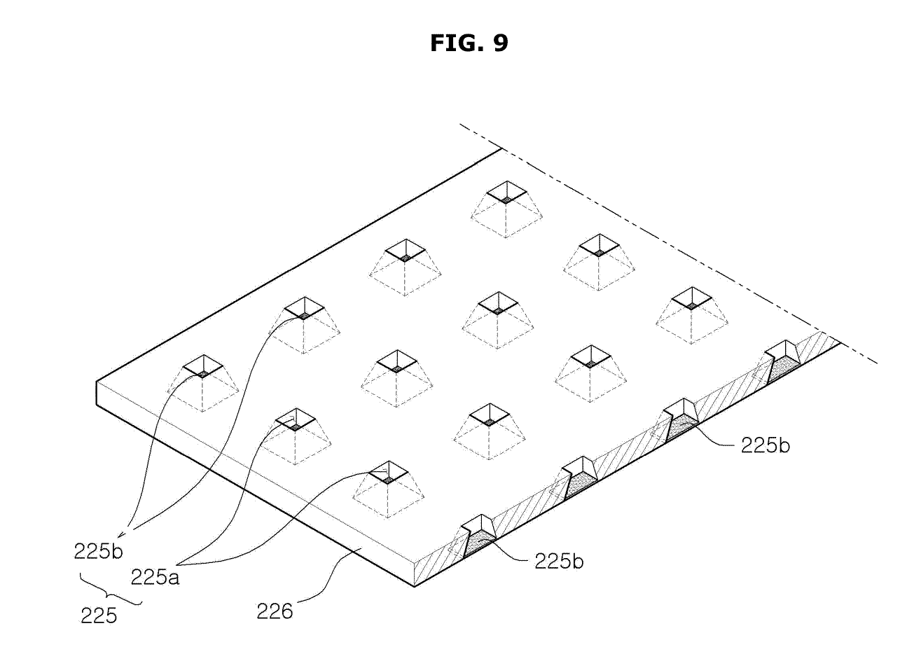

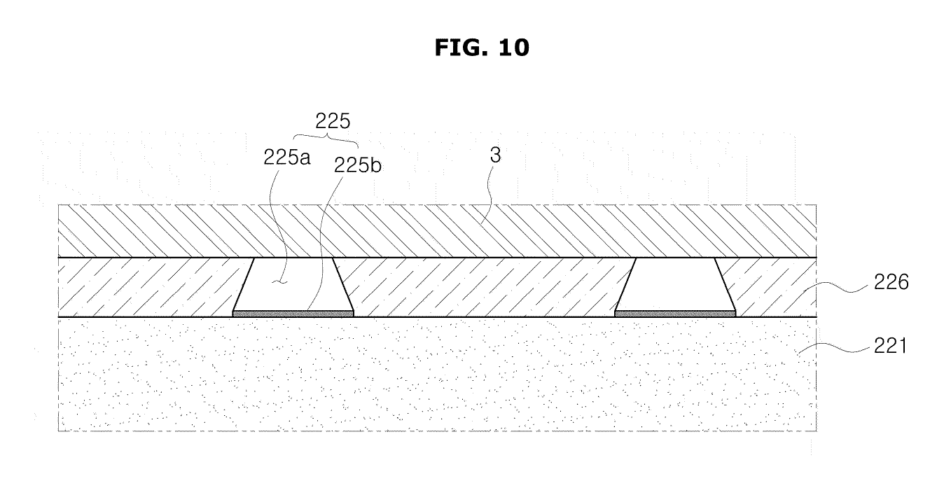

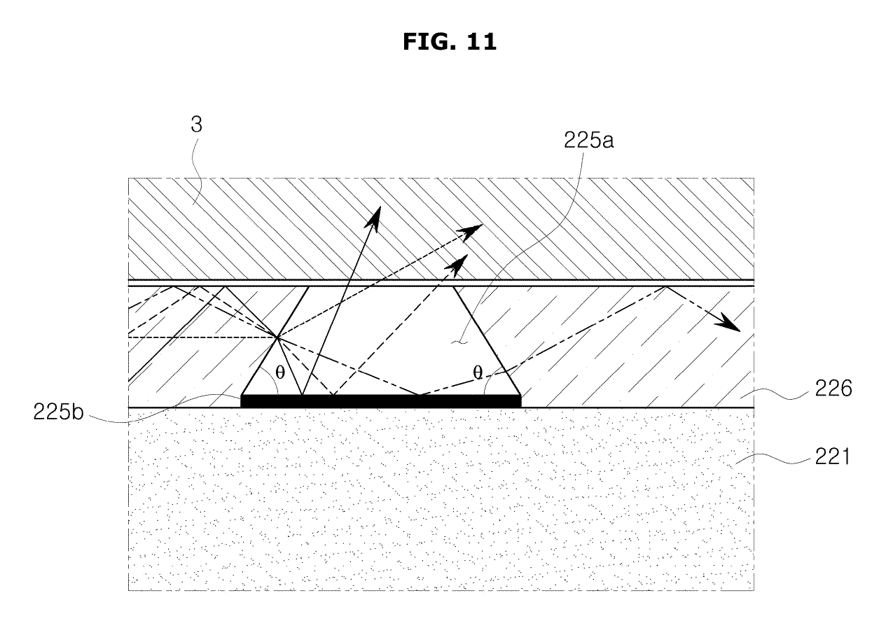

The emission pattern 225 includes concave emission portions 225a provided on the front surface of the emission plate 226, facing toward the rear surface of the display panel 1, and reflecting portions 225b which are provided at inner sides of the rear surfaces of the emission portions 225a and which reflect light, as shown in FIGS. 9 and 10. In this embodiment, the emission portions 225a are provided as hole shapes, but this is merely exemplary. The emission portions 225a may alternately be provided in groove shapes or another shape, as would be understood by one of skill in the art.

The emission portion 225a is formed so that a cross section thereof has a trapezoidal shape. In this embodiment, the emission portion 225a is concavely formed in a square prismoidal shape. An upper side of the emission portion 225a, formed in an isosceles trapezoidal shape, faces the rear surface of the display panel 1, and a reflecting portion 225b described above is formed on a side of the bottom of the emission portion 225a.

With the emission portions 225a, as described above, most light reflected by the front surface of the emission plate 226 is directly emitted to the front of the emission portions 225a of the reflecting portions 225b or is reflected by the reflecting portions 225b and emitted to the front of the emission portions 225a.

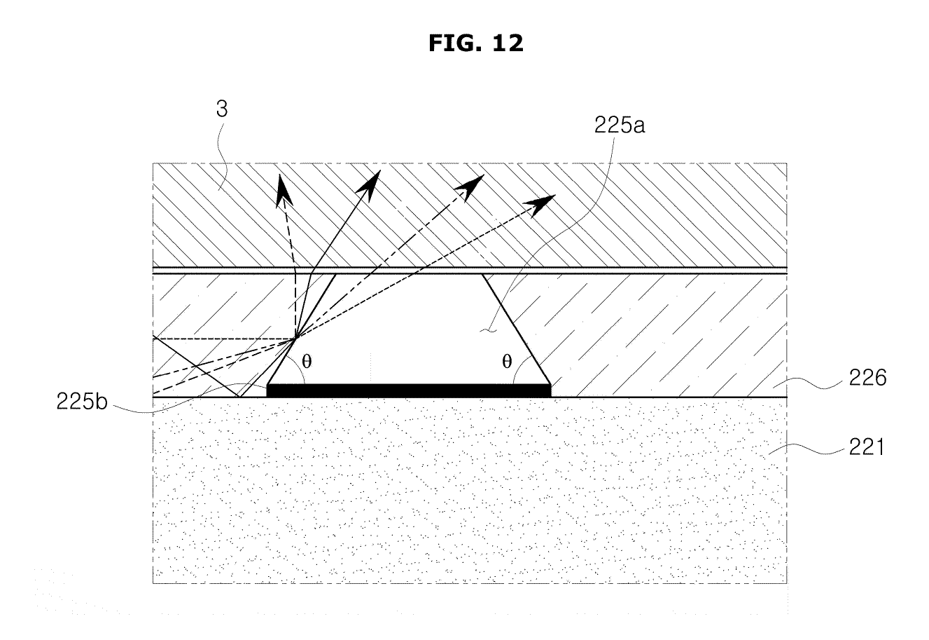

Further, light reflected by the rear surface of the emission plate 226 is also emitted into the emission portions 225a, and a portion of the light is refracted by a difference of refractive indexes between media, and thus, this light is directly emitted to the front of the emission portions 225a as shown in FIG. 12. Further, light incident onto the emission portions 225a at a total angle of reflection or less is totally reflected and is incident to the second light guide 222 to be emitted to the display panel 1.

Therefore, most light incident on both side ends of the emission portion 225a is emitted to the front of the emission portion 225a.

In this embodiment, the emission portions 225a are concavely formed in a square prismoidal shape having isosceles trapezoidal shapes in a vertical direction and a lateral direction, but this is merely exemplary. The emission portions may be formed to have trapezoidal cross sections or may have other shapes, as would be understood by one of skill in the art.

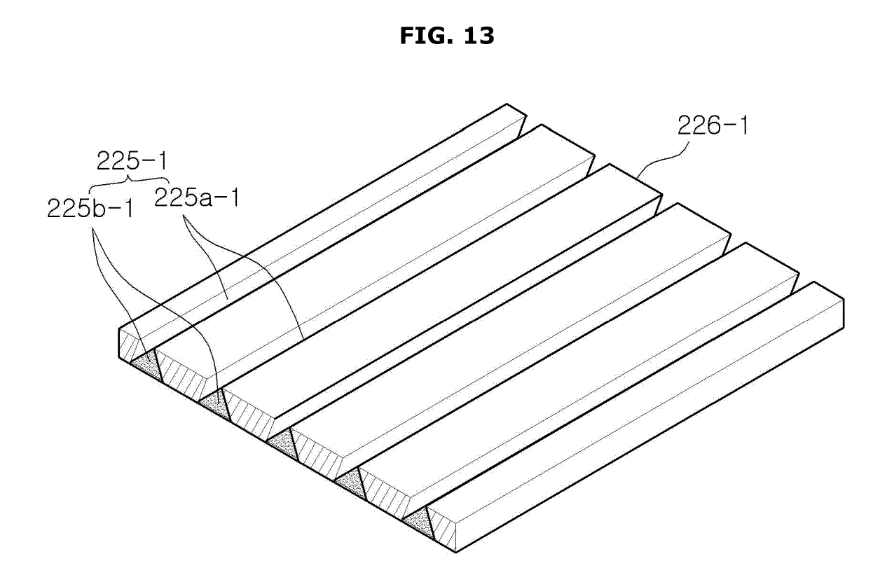

That is, according to a ninth exemplary embodiment of the present invention shown in FIG. 13, emission portions 225a-1 are formed on an emission plate 226-1, and each has a trapezoidal cross section. The reflecting portions 225b-1 are formed long on sides at the bottom of the emission portions 225a-1 so as to extend in one direction in parallel. An emission pattern 225-1 may be formed using the emission portions 225a-1 and the reflecting portions 225b-1 described above.

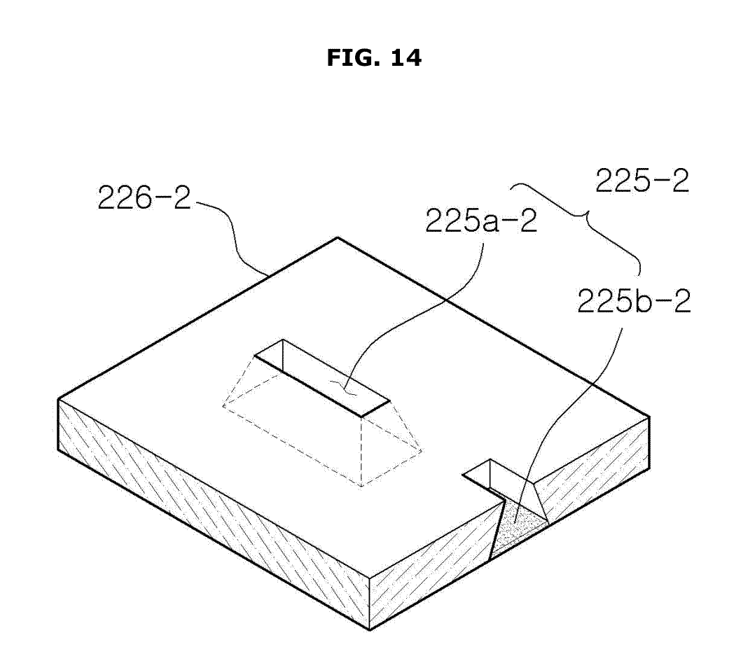

Further, according to a tenth exemplary embodiment shown in FIG. 14, each emission portion 225a-2 is formed on an emission plate 226-2 in a rectangular prismoidal shape formed long in one direction, and each reflecting portion 225b-2 is formed on a side of the bottom of the emission plate 226-2. An emission pattern 225-2 may be formed using the emission portions 225a-2 and the reflecting portions 225b-2 described above. When the emission portions 225a-2 are formed in the rectangular prismoidal shape as described above, an amount of light emitted in a direction perpendicular to a longitudinal side of the emission portion 226a-2 may be increased. Therefore, a viewing angle in a vertical direction and a viewing angle in a lateral direction can be set differently.

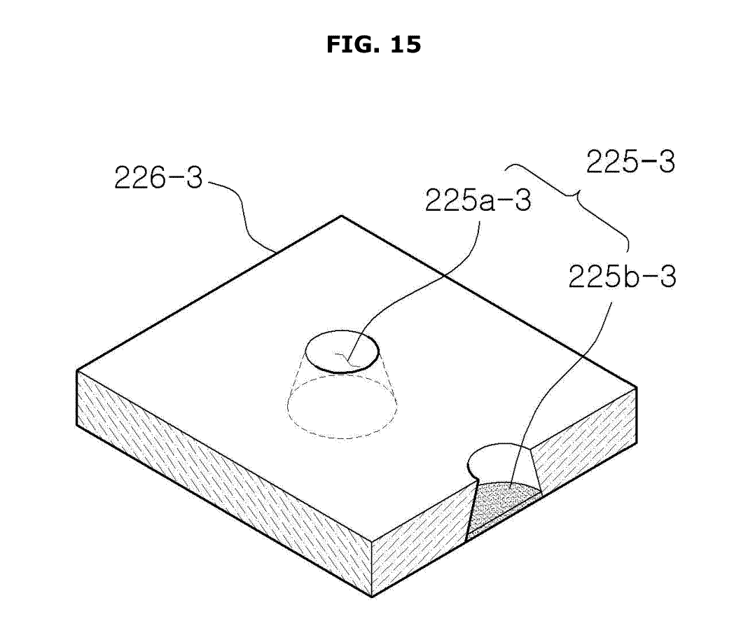

Further, according to an eleventh exemplary embodiment shown in FIG. 15, each emission portion 225a-3 is concavely formed on an emission plate 226-3 in a truncated-cone shape and each reflecting portion 225b-3 is formed on the bottom of the emission plate 226-3. An emission pattern 225-3 may includes the emission portions 225a-3 and the reflecting portions 225b-3. When the emission portions 225a-3 are formed in the truncated cone shape, light is uniformly emitted to all directions over 360 degrees.

Various shapes of the emission portions 225a, 225a-1, 225a-2, and 225a-3 are described with respect to the eighth through eleventh exemplary embodiments. Alternately, any combination of these emission portions 225a, 225a-1, 225a-2, and 225a-3 can be included in a single emission plate. That is, any one of the above-described emission portions 225a, 225a-1, 225a-2, and 225a-3 can be selectively applied to any portion of an emission plate so as to be suitable for desired light characteristics.

In the exemplary embodiments, although the cross sections of the emission portions are an isosceles trapezoidal shape in which both sides thereof are formed to be sloped at the same angle, they are not limited thereto. The emission portions may be formed to have a cross section of a trapezoidal shape in which both sides at the bottom thereof have different angles, or another shape as would be understood by one of skill in the art.

As is apparent from the above description, in a three-dimensional display apparatus according to one or more exemplary embodiments, since a light guide module includes a first light guide, a second light guide, and an emission pattern, and light is transmitted through the second light guide by the emission pattern so as to be emitted to a display panel, viewing distances between the eyes of a user and the display panel are determined by the thickness of the second light guide. Accordingly, the desired thickness of the light guide module can be freely designed by a designer.

Although a few exemplary embodiments have been shown and described, it would be appreciated by those skilled in the art that changes may be made in these embodiments without departing from the principles and spirit of the invention, the scope of which is defined in the claims and their equivalents.

What is claimed is:

1. A three-dimensional (3D) display apparatus, comprising:
a display panel; and
a backlight configured to supply light to the display panel, the backlight comprising:
a plurality of light sources configured to generate light; and
a light guide module configured to guide the light generated by the plurality of light sources to the display panel, the light guide module comprising:
a first planar light guide, wherein at least a first one of the plurality of light sources is configured to emit light to a first end of the first planar light guide and at least a second one of the plurality of light sources is configured to emit light to a second end of the first planar light guide;
a second planar light guide disposed in front of the first light guide; and
a plurality of emission patterns configured to direct light incident into the light guide module toward the display panel.

2. The apparatus according to claim 1, wherein each of the plurality of emission patterns comprises:
a reflecting portion, configured to reflect light and disposed on a rear surface of the emission pattern; and
a scattering portion, configured to scatter light and disposed on a front surface of the emission pattern.

3. The apparatus according to claim 1, wherein the plurality of emission patterns are disposed between the first planar light guide and the second planar light guide.

4. The apparatus according to claim 3, wherein spaces among the plurality of emission patterns are filled with a transparent material.

5. The apparatus according to claim 1, wherein a front surface of the first light guide comprises a plurality of grooves formed therein, wherein the plurality of emission patterns are respectively formed in the plurality of grooves.

6. The apparatus according to claim 1, wherein a rear surface of the second light guide comprises a plurality of grooves formed therein, wherein the plurality of emission patterns are respectively formed in the plurality of grooves.

7. The apparatus according to claim 2, wherein the reflecting portion comprises an air layer.

8. A three-dimensional display apparatus comprising:
a display panel; and
a backlight configured to supply light to the display panel, the backlight comprising:
a pair of light sources configured to generate light; and
a light guide module configured to guide the light generated by the pair of light sources to the display panel, wherein a first one of the pair of light sources is disposed on a first end of the light guide module and a second one of the pair of light sources is disposed on a second end of the light guide module, opposite the first end, the light guide module comprising:
a first planar light guide formed in a plate shape;
a second planar light guide disposed in front of the first planar light guide; and
a scattering pattern configured to scatter light by reflecting light incident from the first light guide at an angle of reflection the same as an angle of incidence, and reflecting light incident from the second light guide at an angle of reflection greater than an angle of incidence.

9. The apparatus according to claim 8, wherein the scattering pattern comprises a light reflective material having a planar rear surface, and a convex front surface.

10. The apparatus according to claim 8, wherein the scattering pattern comprises a light reflective material forming a convex front surface of the scattering pattern, and an air layer forming a rear surface of the scattering portion.

11. A three-dimensional display apparatus comprising:
a display panel; and
a backlight configured to supply light to the display panel, the backlight comprising:
a plurality of light sources configured to generate light; and
a light guide module configured to guide light generated by the plurality of light sources to the display panel, the light guide module comprising:
a planar light guide, wherein at least a first one of the plurality of light sources is configured to emit light to a first end of the planar light guide and at least a second one of the plurality of light sources is configured to emit light to a second end of the planar light guide; and
a planar emission plate disposed in front of the light guide,
wherein the emission plate comprises an emission pattern which directs light from the light guide module toward the display panel.

12. The apparatus according to claim 11, wherein the emission pattern comprises a plurality of concave emission portions formed in a front surface of the emission plate, and a plurality of reflecting portions respectively disposed on rear surfaces of the plurality of emission portions.

13. The apparatus according to claim 12, wherein an upper side of each of the plurality of emission portions has a trapezoidal cross-section facing a rear surface of the light guide.

14. The apparatus according to claim 13, wherein the plurality of emission portions extend in a same direction in parallel.

15. The apparatus according to claim 13, wherein each of the plurality of emission portions has a prismoidal shape.

16. The apparatus according to claim 15, wherein each of the plurality of emission portions has a square prismoidal shape.

17. The apparatus according to claim 15, wherein each of the plurality of emission portions has a rectangular prismoidal shape.

18. The apparatus according to claim 13, wherein each of the plurality of emission portions has a truncated cone shape.
